(19) United States
(12) Patent Application Publication
(10) Pub. No.: US 2010/0207737 A1
(43) Pub. Date: Aug. 19, 2010

(54) TDMA CONTROL METHOD USED BY RFID READER VIA MOBILE PHONE BASE STATION AND MOBILE RFID READER

(75) Inventors: Chan-Won Park, Daejeon-city (KR); Nak-Seon Seong, Daejeon-city (KR); Josef Preishuber-Pfluegl, Klagenfurt (AT); David Tschische, Klagenfurt (AT); Gil-Young Choi, Daejeon-city (KR); Cheol-Sig Pyo, Daejeon-city (KR); Jong-Suk Chae, Daejeon-city (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon-city (KR)

(21) Appl. No.: 12/682,319

(22) PCT Filed: Oct. 13, 2008
(86) PCT No.: PCT/KR2008/006012

§ 371 Date: Apr. 9, 2010

(30) Foreign Application Priority Data
Oct. 12, 2007 (KR) 10-2007-0103149
Aug. 8, 2008 (KR) 10-2008-0078119

(51) Int. Cl. G06K 17/00

(52) U.S. Cl. 340/10.2

(57) ABSTRACT

A time division multiple access (TDMA) control method used by a mobile radio frequency identifier (RFID) reader through a mobile phone base station and a mobile RFID reader are provided. Each mobile RFID reader occupies a frequency channel during a time slot allocated through a mobile communication base station, thereby avoiding interference between readers.

### TECHNICAL FIELD

The present invention relates to a mobile radio frequency identifier (RFID) reader control method, and more particularly to, a time division multiplexing (TDM) control method applicable to a mobile RFID reader via a mobile phone base station.

The present invention is supported by the Information Technology (IT) Research & Development (R&D) program of the Ministry of Information and Communication (MIC) and the Institute for Information Technology Advancement (IITA) [2006-S-023-02, Development of Advanced RFID System Technology].

This application claims the benefit of Korean Patent Application Nos. 10-2007-0103149, filed on Oct. 12, 2007, 10-2008-0078119, filed on Aug. 8, 2008, in the Korean Intellectual Property Office, the disclosure of which is incorporated herein in its entirety by reference.

### BACKGROUND ART

FIG. 1 is a conceptual diagram of interference between readers. Referring to FIG. 1, the interference or collision between readers has been a critical problem in a multiple reader environment where a plurality of readers is used in a specific region. To address this problem, a listen before talk (LBT) of detecting a channel status before a reader sends a message or a method of randomly selecting a channel from limited channels has been used. However, such algorithms have failed to solve a problem, such as a hidden terminal.

Frequency division multiplexing (FDM) has been generally used to reduce the interference quantity between readers, and has been standardized (ETSI TS 102 562 v1.1.1) by the European Telecommunications Standards Institute (ETSI). However, the conventional method of reducing the interference quantity by using the FDM has a disadvantage in the limited number of available channels. In particular, when an art exhibition uses a mobile RFID reader that reads tag information so as to display meta content, several tens or hundreds of mobile RFID readers are required in a small region, which needs a new reader interference prevention technique.

Although time division multiplexing (TDM) is used to temporally divide a channel that can be shared by a plurality of readers, it is difficult to implement the TDM in an environment where there is no central device for allocating timeslots to different end equipments. A centralized master node needs a dedicated control channel in order to receive a channel allocation request from a mobile device and transmit authorization and a status message to the mobile device. The centralized master node can be easily implemented by connecting a fixed RFID reader over Ethernet in a wired communication network. However, since a mobile RFID reader has not central network management node, it is difficult to implement the mobile RFID reader and thus the TDM has not been widely used for a mobile RFID field up to now.

### DISCLOSURE OF INVENTION

### Technical Problem

An effective mobile radio frequency identifier (RFID) reader control method is needed.

### Technical Solution

The present invention provides a time division multiplexing (TDM) control method applicable to a mobile radio frequency identifier (RFID) reader.

The present invention also provides a method of avoiding interference between readers applicable to a mobile RFID reader.

### Advantageous Effects

The present invention allocates frequency channels and RFID communication channels regarding time slots over a mobile communication base station to a mobile RFID reader, thereby controlling mobile RFID readers by using TDM.

Therefore, each mobile RFID reader occupies an allocated frequency and time slot, thereby avoiding interference between readers.

Also, a base station and mobile RFID readers use a given channel of a corresponding network to communicate RFID communication channel information, which extends a given network protocol, thereby allocating channels for an RFID communication without establishing an additional control channel.

### DESCRIPTION OF DRAWINGS

The above and other features and advantages of the present invention will become more apparent by describing in detail exemplary embodiments thereof with reference to the attached drawings in which:

FIG. 1 is a conceptual diagram of interference between readers;

FIG. 2 is a schematic diagram of a mobile radio frequency identifier (RFID) system according to an embodiment of the present invention;

FIG. 3 illustrates an available combination of frequency division multiplexing (FDM) and time division multiplexing (TDM) according to an embodiment of the present invention;

FIG. 4 illustrates a method of controlling a time division multiple access (TDMA) of a mobile RFID reader and communicating between the mobile RFID reader and a tag over a global system for mobile communication (GSM) base transceiver station according to an embodiment of the present invention;

FIG. 5 illustrates the structure of a mobile RFID reader that communicates with a mobile communication network base station according to an embodiment of the present invention ; and

FIG. 6 is a flowchart of an RFID communication method performed by a mobile RFID reader and a base station according to an embodiment of the present invention.

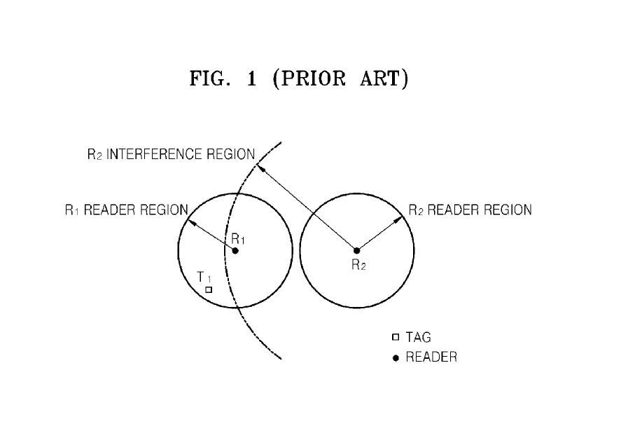

### BEST MODE

According to an aspect of the present invention, there is provided a time division multiple access (TDMA) control method used by a mobile radio frequency identifier (RFID) reader, the method comprising: requesting a channel used to perform an RFID communication with a tag via an uplink channel for a base transceiver station according to a protocol of a corresponding mobile communication network; and receiving at least one piece of channel information among a transmission channel and a transmission window via a downlink channel from the base transceiver station according to the protocol of the corresponding mobile communication network.

The transmission window may include information about the number and location of time slots, and the time slots may be generated based on a system clock synchronized to a specific pattern of a frame broadcasted by the base transceiver station.

The method may further comprise: transmitting historic information collected during an inventory round to the base transceiver station after the inventory round ends.

The method may further comprise: exchanging the at least one piece of channel information with another mobile RFID reader.

The mobile communication network may comprise a global system for mobile communication (GSM) network, an universal mobile telecommunications system (UMTS) network, a code division multiple access (CDMA) network, and a wideband-CDMA (W-CDMA) network.

According to another aspect of the present invention, there is provided a TDMA control method used by a mobile RFID reader, the method comprising: requesting a channel used to perform an RFID communication with a tag via an random access channel (RACH) for a base transceiver station that covers a mobile communication network cell to which a specific frequency spectrum is allocated; and receiving at least one piece of channel information among a transmission channel and a transmission window via an access grant channel (AGCH) from the base transceiver station.

According to another aspect of the present invention, there is provided a TDMA control method used by a mobile RFID reader by using a base transceiver station, the method comprising: receiving a request of the mobile RFID reader for a channel used to perform an RFID communication with a tag via an uplink channel according to a protocol of a corresponding mobile communication network; and allocating at least one piece of channel information among a transmission channel and a transmission window via a downlink channel according to the protocol of the corresponding mobile communication network in response to the request.

According to another aspect of the present invention, there is provided a mobile RFID reader comprising: a mobile communicating unit requesting a channel used to perform an RFID communication via an uplink channel for a base transceiver station according to a protocol of a corresponding mobile communication network, and receiving at least one piece of channel information among a transmission channel and a transmission window via a downlink channel from the base transceiver station according to the protocol of the corresponding mobile communication network; and an RFID reader unit performing the RFID communication with a tag based on the at least one piece of channel information.

According to another aspect of the present invention, there is provided a mobile RFID communication system comprising: a mobile communication network base station allocating at least one piece of channel information among an RFID transmission channel and an RFID transmission window via a channel according to a protocol of a network; and a mobile station comprising an RFID reader, generating time slots based on a specific pattern of a burst frame broadcasted by the base station, and performing an RFID communication with a tag during a designated time slot in a frequency allocated in response to the request of the channel information.

### Mode for Invention

The present invention will now be described more fully with reference to the accompanying drawings, in which exemplary embodiments of the invention are shown. Although like elements are shown in different figures, like reference numerals in the drawings denote like elements. While describing the present invention, detailed descriptions about related well known functions or configurations that may blur the points of the present invention are omitted.

Unless explicitly described to the contrary, the word ‘comprise’ and variations such as ‘comprises’ or ‘comprising’, will be understood to imply the inclusion of stated elements but not the exclusion of any other elements. The term ‘unit’ in the embodiments of the present invention means a software component or hardware components or a combination thereof, and performs a specific function or operation.

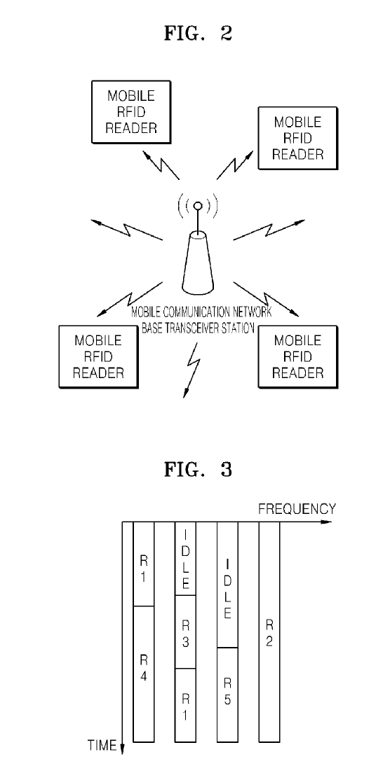

FIG. 2 is a schematic diagram of a mobile radio frequency identifier (RFID) system according to an embodiment of the present invention. Referring to FIG. 2, the mobile RFID system of the present embodiment is a communication system comprising a plurality of RFID readers (hereinafter, mobile RFID readers or mobile RFID phones) embedded in a mobile station and a base station for a mobile communication network (or Mobile communication network base transceiver station).

The base station, which is a base transceiver station for the mobile communication network, allocates RFID communication channels and/or RFID communication time slots for the plurality of mobile RFID readers, and may include a global system for mobile communication (GSM) base transceiver station, an universal mobile telecommunications system (UMTS) base transceiver station, a code division multiple access (CDMA) base transceiver station, and a wideband-CDMA (W-CDMA) base transceiver station.

The base transceiver station may cover cells of a partial region to which a specific frequency spectrum of a whole network is allocated. In this case, the base transceiver station managing the cells and the mobile RFID readers inside the cells communicate each other in each cell.

The mobile RFID readers may receive the RFID communication channels and time slots from the base transceiver station for the mobile communication network and resume an inventory operation. The mobile RFID readers may transmit history information collected during the inventory operation to the base transceiver station for the mobile communication network after the inventory operation ends. The history information may include information about collision or interference between readers.

Although it is not indispensable to the mobile RFID readers to support a mobile communication method other than the RFID, most RFID readers are expected to be included in a mobile phone in the future, and thus it is readily expected that different protocols will need an interface.

FIG. 3 illustrates an available combination of frequency division multiplexing (FDM) and time division multiplexing (TDM) according to an embodiment of the present invention. Referring to FIG. 3, a base transceiver station multiplexes 5 mobile RFID readers R1-R5 in four available frequency channels. Each of the mobile RFID readers R1-R5 receives a different frequency and time slot for an RFID communication from the base transceiver station. Therefore, each of the mobile RFID readers R1-R5 can communicate with a tag without causing collision with another RFID reader.

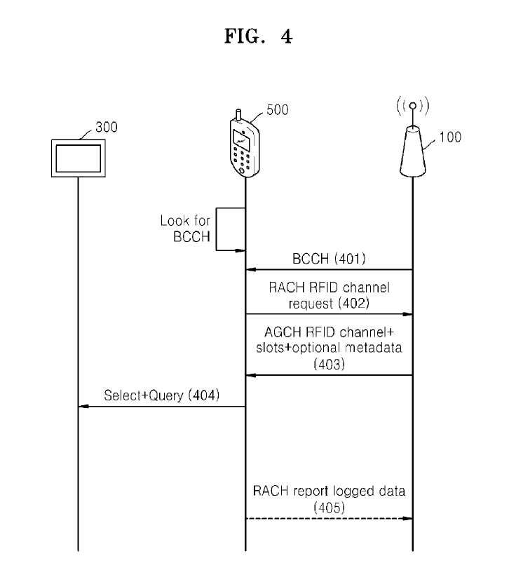

FIG. 4 illustrates a method of controlling a time division multiple access (TDMA) of a mobile RFID reader 500 and communicating between the mobile RFID reader 500 and a tag 300 over a GSM base transceiver station 100 according to an embodiment of the present invention.

The present embodiment may use a given mobile communication standard utilizing a base transceiver station based cell concept. In the present embodiment, a GSM network is used to describe the present embodiment.

In the present embodiment, in order to avoid complexity of a system or a great change in a given GSM standard, a new GSM control channel is not established but the conventional structure is basically utilized.

A given GSM protocol may be extended so as to transmit RFID related meta information. Similarly to operations necessary for implementing a call in the GSM, the GSM base transceiver station 100 may be used as a central point (CP) for a mobile device that requires an RFID transmission channel and time slot necessary for starting an RFID inventory round. The RFID transmission channel and time slot are needed to resume an RFID inventory. The GSM base transceiver station 100 manages TDM of all RFID readers in GSM cells.

Referring to FIG. 4, the mobile RFID reader 500 uses a burst frame that is received from a broadcast control channel (BCCH) from the GSM base transceiver station 100 to fit a timing sync between readers in operation 401. The mobile RFID reader 500 uses the timing sync to make time slots for an RFID TDMA transmission.

The mobile RFID reader 500 requests a channel for the GSM base transceiver station 100 so as to send an instruction to the tag 300 in operation 402. In this regard, a random access channel (RACH) is used to request an unused channel.

Similarly to the channel request of the GSM communication, the GSM base transceiver station 100 grants an access grant channel (AGCH) in operation 403. The GSM base transceiver station 100 transmits information about the frequency channel and time slots besides selective meta data to the mobile RFID reader 500.

If the mobile RFID reader 500 gets a grant of a specific channel by using an AGCH signal, the mobile RFID reader 500 resumes the inventory round to the selected tag 300, and occupies a corresponding channel during the time slot designated by the GSM base transceiver station 100 in operation 404.

The mobile RFID reader 500 may report historic data collected during the inventory operation, i.e., information about the number of collisions, to the GSM base transceiver station 100 after the inventory round ends.

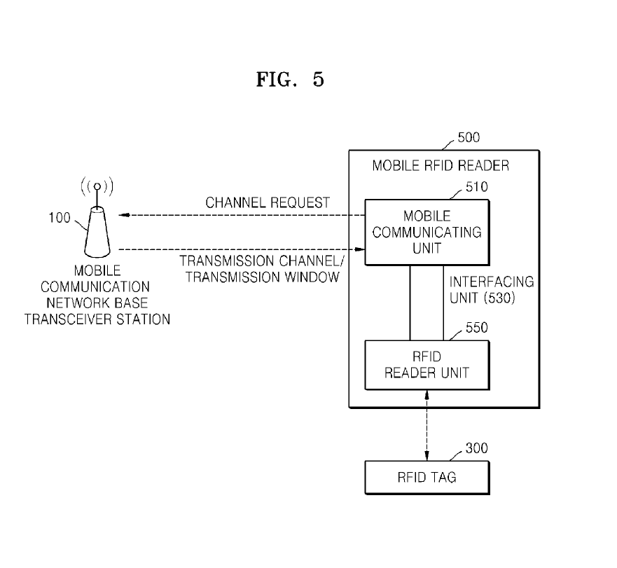

FIG. 5 illustrates the structure of a mobile RFID reader 500 that communicates with a mobile communication network base station 100 according to an embodiment of the present invention. Referring to FIG. 5, the mobile RFID reader 500 of the present embodiment comprises a mobile communicating unit 510, an interfacing unit 530, and an RFID reader unit 550.

The mobile communicating unit 510 communicates with the mobile communication network base station 100, such as GSM, UMTS, CDMA, W-CDMA, etc. The mobile communicating unit 510 requests a channel used to perform an RFID communication with an RFID tag 300 via an uplink channel for the mobile communication network base station 100 according to a protocol of a corresponding mobile communication network, and receives at least one piece of channel information among a transmission frequency channel and a transmission window via a downlink channel from the mobile communication network base station 100 according to the protocol of the corresponding mobile communication network. The transmission window includes information about the number and location of time slots.

The mobile communicating unit 510 transmits historic data collected during an inventory round of the RFID reader unit 550 to the mobile communication network base station 100 after the inventory round ends.

The mobile communicating unit 510 receives a downlink frame broadcasted by the mobile communication network base station 100, and generates a clock sync signal for clock sync from a specific pattern of the received downlink frame. The specific pattern may be a start point of a frame or a start point of a burst. The mobile communicating unit 510 may transfer a result of detecting the starting point of the frame or the starting point of the burst or a clock sync signal generated by using the result to the RFID reader unit 550 immediately or after a predetermined delay period of time.

The interfacing unit 530 transfer the result of detecting the starting point of the frame or the starting point of the burst or the clock sync signal generated by using the result to the RFID reader unit 550. The interfacing unit 530 transfers the channel information received by the mobile communicating unit 510 to the RFID reader unit 550.

The RFID reader unit 550 communicates data with the RFID tag 300 through the RFID communication. The RFID reader unit 550 is synchronized with the clock sync signal generated by the mobile communicating unit 510, shares a system clock with another mobile RFID reader, and generates time slots based on the shared system clock. The RFID reader unit 550 uses clock tick information received from the mobile communicating unit 510 to determine a start and an end of the time slots.

The RFID reader unit 550 performs the RFID communication with the RFID tag 300 during the time slot designated by the frequency allocated according to the channel information. The RFID reader unit 550 stores the historic information, such as information about collisions occurred during the inventory round.

The RFID reader unit 550 exchanges the channel information and/or information including the estimated number of RFID tags located in a network or a specific region of a cell with another mobile RFID reader, thereby avoiding collisions between RFID readers and enhancing an RFID inventory process.

The mobile communication network base station 100 allocates an RFID communication channel to the mobile RFID reader 500 that is to communicate with the RFID tag 300 based on a history of channels allocated in each mobile RFID reader.

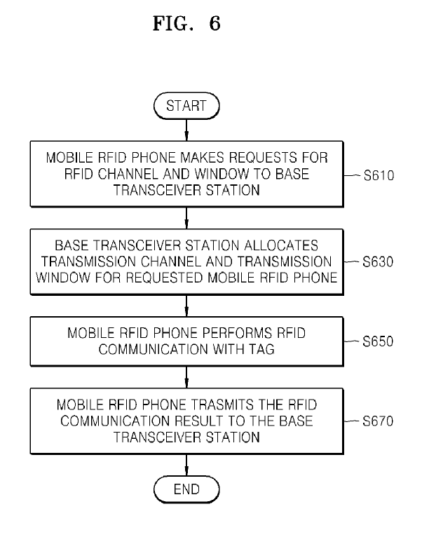

FIG. 6 is a flowchart of an RFID communication method performed by a mobile RFID reader and a base station according to an embodiment of the present invention. Hereinafter, the same description as in the previous embodiments will now be repeated.

Referring to FIG. 6, the mobile RFID reader requests a channel used to perform an RFID communication with a tag via an uplink channel for a base transceiver station according to a protocol of a corresponding mobile communication network in operation 610. The mobile RFID reader makes requests for RFID channel and window to base transceiver station. In a GSM network, an RACH may be used to request the channel.

The base transceiver station allocates at least one piece of channel information among a transmission channel and a transmission window via a downlink channel to the mobile RFID reader according to the protocol of the corresponding mobile communication network in operation 630. The transmission window includes information about the number and location of time slots. In the GSM network, an AGCH may be used to allocate the channel information.

The mobile RFID reader performs an RFID communication with a tag selected during a time slot designated in a frequency channel allocated according to the channel information in operation 650.

The mobile RFID reader transmits historic information collected during an inventory round to the base transceiver station after the inventory round ends in operation 670. The mobile RFID reader transmits the RFID communication result to the base transceiver station. In the GSM network, the RACH may be used to transmit the historic information to the base transceiver station.

The mobile RFID reader generates the time slot based on a specific pattern of a frame that is previously broadcasted by the base transceiver station, and is synchronized to the specific pattern of the received frame in order to determine a start and an end of the time slot, thereby using clock tic information according to a system clock that the mobile RFID reader shares with another mobile RFID reader. In the GSM network, the mobile RFID reader may receive a burst frame from the base transceiver station via a BCCH and synchronize a clock.

Meanwhile, the mobile RFID reader may exchange its own channel information with another mobile RFID reader.

To implement the present invention, a set of instructions used for a mobile communication, such as a GSM communication, needs to be changed to transmit an RFID channel allocation request message. The base transceiver station needs to enable a TDMA management for an RFID. Such technique can be implemented by using a simple round Robin method.

In alternative embodiments, hard-wired circuitry may be used in place of or in combination with processor/controller programmed with computer software instructions to implement the invention. Thus, embodiments of the invention are not limited to any specific combination of hardware circuitry and software.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion. Also, functional programs, code and code segments for accomplishing the present invention can be easily construed by programmer skilled in the art to which the present invention pertains.

Terms used above are intended to depict example embodiments and should not be interpreted to limit the intended scope of the claims.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A time division multiple access (TDMA) control method used by a mobile radio frequency identifier (RFID) reader, the method comprising:
requesting a channel used to perform an RFID communication with a tag via an uplink channel for a base transceiver station according to a protocol of a corresponding mobile communication network; and
receiving at least one piece of channel information among a transmission channel and a transmission window via a downlink channel from the base transceiver station according to the protocol of the corresponding mobile communication network.

2. The method of claim 1, wherein the transmission window includes information about the number and location of time slots.

3. The method of claim 2, wherein the time slots are generated based on a system clock synchronized to a specific pattern of a frame broadcasted by the base transceiver station.

4. The method of claim 1, further comprising: transmitting historic information collected during an inventory round to the base transceiver station after the inventory round ends.

5. The method of claim 1, further comprising: exchanging the at least one piece of channel information with another mobile RFID reader.

6. The method of claim 1, wherein the mobile communication network comprises a global system for mobile communication (GSM) network, an universal mobile telecommunications system (UMTS) network, a code division multiple access (CDMA) network, and a wideband-CDMA (W-CDMA) network.

7. A TDMA control method used by a mobile RFID reader, the method comprising:
requesting a channel used to perform an RFID communication with a tag via an random access channel (RACH) for a base transceiver station that covers a mobile communication network cell to which a specific frequency spectrum is allocated; and
receiving at least one piece of channel information among a transmission channel and a transmission window via an access grant channel (AGCH) from the base transceiver station.

8. The method of claim 7, wherein the transmission window includes information about the number and location of time slots.

9. The method of claim 8, wherein the time slots are generated based on a system clock synchronized to a specific pattern of a burst frame received via a broadcast control channel from the base transceiver station.

10. The method of claim 7, further comprising: transmitting historic information collected during an inventory round to the base transceiver station via the RACH after the inventory round ends.

11. A TDMA control method used by a mobile RFID reader by using a base transceiver station, the method comprising:
receiving a request of the mobile RFID reader for a channel used to perform an RFID communication with a tag via an uplink channel according to a protocol of a corresponding mobile communication network; and
allocating at least one piece of channel information among a transmission channel and a transmission window via a downlink channel according to the protocol of the corresponding mobile communication network in response to the request.

12. The method of claim 11, wherein the transmission window includes information about the number and location of time slots.

13. The method of claim 11, wherein the base transceiver station manages cells of a region to which a part of a frequency spectrum covered by the mobile communication network is allocated.

14. The method of claim 11, wherein the mobile communication network comprises a GSM network, an UMTS network, a CDMA network, and a W-CDMA network.

15. A mobile RFID reader comprising:
a mobile communicating unit requesting a channel used to perform an RFID communication via an uplink channel for a base transceiver station according to a protocol of a corresponding mobile communication network, and receiving at least one piece of channel information among a transmission channel and a transmission window via a downlink channel from the base transceiver station according to the protocol of the corresponding mobile communication network; and
an RFID reader unit performing the RFID communication with a tag based on the at least one piece of channel information.

16. The mobile RFID reader of claim 15, wherein the transmission window includes information about the number and location of time slots.

17. The mobile RFID reader of claim 16, wherein the RFID reader unit generates time slots based on a system clock synchronized to a specific pattern of a frame broadcasted by the base transceiver station.

18. The mobile RFID reader of claim 15, wherein the mobile communication network comprises a GSM network, an UMTS network, a CDMA network, and a W-CDMA network.

19. A mobile RFID communication system comprising:
a mobile communication network base station allocating at least one piece of channel information among an RFID transmission channel and an RFID transmission window via a channel according to a protocol of a network; and
a mobile station comprising an RFID reader, generating time slots based on a specific pattern of a burst frame broadcasted by the base station, and performing an RFID communication with a tag during a designated time slot in a frequency allocated in response to the request of the channel information.

20. The mobile RFID communication system of claim 19, wherein the mobile communication network comprises a GSM network, an UMTS network, a CDMA network, and a W-CDMA network.
